(19) United States
(12) Patent Application Publication
(10) Pub. No.: US 2012/0307513 A1
(43) Pub. Date: Dec. 6, 2012

(54) LIGHT SOURCE GUIDING STRUCTURE AND LAMP STRUCTURE

(75) Inventors: YI-JU LI, YILAN COUNTY (TW); CHIN-KAI HUANG, YILAN COUNTY (TW); HUNG-WEI CHEN, TAOYUAN COUNTY (TW); SHIH-MIN WU, TAOYUAN COUNTY (TW); CHIA CHI LIU, TAIPEI CITY (TW)

(73) Assignee: LUSTROUS TECHNOLOGY LTD., NEW TAIPEI CITY (TW)

(21) Appl. No.: 13/242,980

(22) Filed: Sep. 23, 2011

(30) Foreign Application Priority Data
Jun. 3, 2011 (TW) 100210179

(51) Int. Cl. F21V 8/00

(52) U.S. Cl. 362/555; 362/551

(57) ABSTRACT

A lamp structure includes an electrical connection unit, a light emitting unit, and a light guiding unit. The electrical connection unit includes an electrical connection element. The light emitting unit includes at least one light emitting element disposed on the top side of the electrical connection unit and electrically connected to the electrical connection element. The light guiding unit includes a light guiding element disposed on the top side of the electrical connection unit. The light guiding element has a bottom light-input surface, a top light-output surface, and a surrounding light-output surface. The surrounding light-output surface has a first surrounding region gradually outwardly expanded from bottom to top, a second surrounding region connected to the first surrounding region and gradually inwardly contracted from bottom to top, and a third surrounding region connected to the second surrounding region and gradually outwardly expanded from bottom to top.

### BACKGROUND OF THE INVENTION

1. Field of the Invention

The instant disclosure relates to a light source guiding structure and a lamp structure, and more particularly, to a light source guiding structure and a lamp structure for concentrating light source at a predetermined position in order to increase the illumination range.

2. Description of Related Art

The invention of the lamp greatly changes the style of building construction and the lifestyle of human beings, allowing people to work during the night. Traditional lighting devices such as lamps that adopt incandescent bulbs, fluorescent bulbs, or power-saving bulbs have been generally well-developed and used intensively for indoor illumination.

Moreover, compared to the newly developed light-emitting-diode (LED) lamps, these traditional lamps have the disadvantages of quick attenuation, high power consumption, high heat generation, short service life, high fragility, and being not recyclable. Thus, various high-powered LED lamps are created to replace the traditional lighting devices.

### SUMMARY OF THE INVENTION

One aspect of the instant disclosure relates to a light source guiding structure for concentrating light source generated by the light source guiding structure at a predetermined position in order to increase the illumination range.

Another aspect of the instant disclosure relates to a lamp structure for concentrating light source generated by the lamp structure at a predetermined position in order to increase the illumination range.

One of the embodiments of the instant disclosure provides a light source guiding structure, comprising: a light guiding unit and a light emitting unit. The light guiding unit includes at least one light guiding element, wherein the at least one light guiding element has a light condensing zone therein, the at least one light guiding element has at least one bottom light-input surface and at least one top light-output surface respectively formed on the bottom side and the top side thereof, the at least one light guiding element has at least one surrounding light-output surface formed on the external periphery thereof, and the at least one surrounding light-output surface has a first surrounding region gradually outwardly expanded from bottom to top, a second surrounding region connected to the first surrounding region and gradually inwardly contracted from bottom to top, and a third surrounding region connected to the second surrounding region and gradually outwardly expanded from bottom to top. The light emitting unit includes at least one light emitting element facing the at least one bottom light-input surface. Furthermore, the at least one surrounding light-output surface has a fourth surrounding region connected to the third surrounding region and gradually inwardly contracted from bottom to top.

Another one of the embodiments of the instant disclosure provides a lamp structure, comprising: an electrical connection unit, a light emitting unit, and a light guiding unit. The electrical connection unit includes at least one electrical connection element disposed on the bottom side thereof. The light emitting unit includes a light emitting module disposed on the top side of the electrical connection unit, wherein the light emitting module includes at least one light emitting element electrically connected to the at least one electrical connection element. The light guiding unit includes at least one light guiding element disposed on the top side of the electrical connection unit, wherein the at least one light guiding element has a light condensing zone therein, the at least one light guiding element has at least one bottom light-input surface and at least one top light-output surface respectively formed on the bottom side and the top side thereof, the at least one light emitting element faces the at least one bottom light-input surface, the at least one light guiding element has at least one surrounding light-output surface formed on the external periphery thereof, and the at least one surrounding light-output surface has a first surrounding region gradually outwardly expanded from bottom to top, a second surrounding region connected to the first surrounding region and gradually inwardly contracted from bottom to top, and a third surrounding region connected to the second surrounding region and gradually outwardly expanded from bottom to top. Moreover, the at least one surrounding light-output surface has a fourth surrounding region connected to the third surrounding region and gradually inwardly contracted from bottom to top.

Furthermore, the lamp structure further comprising: a retaining unit including a retaining element disposed on the top side of the electrical connection unit, wherein the retaining element has a receiving space for exposing the light emitting unit and receiving the bottom retaining seat and at least two second retaining portions disposed inside the receiving space, and the at least two first retaining portions are respectively slidably mated with the at least two second retaining portions. In addition, the lamp structure further comprising: a lamp cover unit including a light permitting cover covering the light emitting unit and at least one third retaining portion disposed on the bottom side of the light permitting cover to mate with the retaining element, wherein the retaining element has a fourth retaining portion disposed on the outer periphery thereof, and the at least one third retaining portion and the fourth retaining portion are mated with each other.

Another one of the embodiments of the instant disclosure provides a light source guiding structure, comprising: a light guiding unit and a light emitting unit. The light guiding unit includes at least one light guiding element, wherein the at least one light guiding element has a light condensing zone therein, the at least one light guiding element has at least one bottom light-input surface and at least one top light-output surface respectively formed on the bottom side and the top side thereof, and the at least one light guiding element has at least one surrounding light-output surface formed on the external periphery thereof. The light emitting unit includes at least one light emitting element facing the at least one bottom light-input surface.

Therefore, because the at least one light guiding element has at least one bottom light-input surface, at least one top light-output surface, and at least one surrounding light-output surface, light source generated by the light source guiding structure and the lamp structure can be concentrated at a predetermined position in order to increase the illumination range of the instant disclosure.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1A shows one perspective, exploded, schematic view of the lamp structure according to the first embodiment of the instant disclosure;

FIG. 1B shows another perspective, exploded, schematic view of the lamp structure according to the first embodiment of the instant disclosure;

FIG. 2A shows a partial, perspective, assembled, schematic view of the lamp structure before rotating the light guiding unit to combine with the retaining unit according to the first embodiment of the instant disclosure;

FIG. 2B shows a partial, perspective, assembled, schematic view of the lamp structure after rotating the light guiding unit to combine with the retaining unit according to the first embodiment of the instant disclosure;

FIG. 2C shows a perspective, schematic view of the light guiding unit before rotating the light guiding unit to combine with the retaining unit according to the first embodiment of the instant disclosure;

FIG. 2D shows a perspective, schematic view of the light guiding unit after rotating the light guiding unit to combine with the retaining unit according to the first embodiment of the instant disclosure;

FIG. 3 shows a perspective, assembled, schematic view of the lamp structure according to the first embodiment of the instant disclosure;

FIG. 4A shows a cross-sectional view taken along the section line 4A-4A of FIG. 2C;

FIG. 4B shows a cross-sectional view taken along the section line 4B-4B of FIG. 3;

FIG. 5 shows an optical path simulation diagram of the light guiding unit of the lamp structure according to the first embodiment of the instant disclosure;

FIG. 6A shows a cross-sectional view of the light guiding unit of the lamp structure according to the second embodiment of the instant disclosure;

FIG. 6B shows an optical path simulation diagram of the light guiding unit of the lamp structure according to the second embodiment of the instant disclosure;

FIG. 7A shows a perspective, schematic view of the light guiding unit of the lamp structure according to the third embodiment of the instant disclosure; and

FIG. 7B shows a cross-sectional view taken along the section line 7B-7B of FIG. 7A.

### DETAILED DESCRIPTION OF THE PREFERRED EMBODIMENTS

### First Embodiment

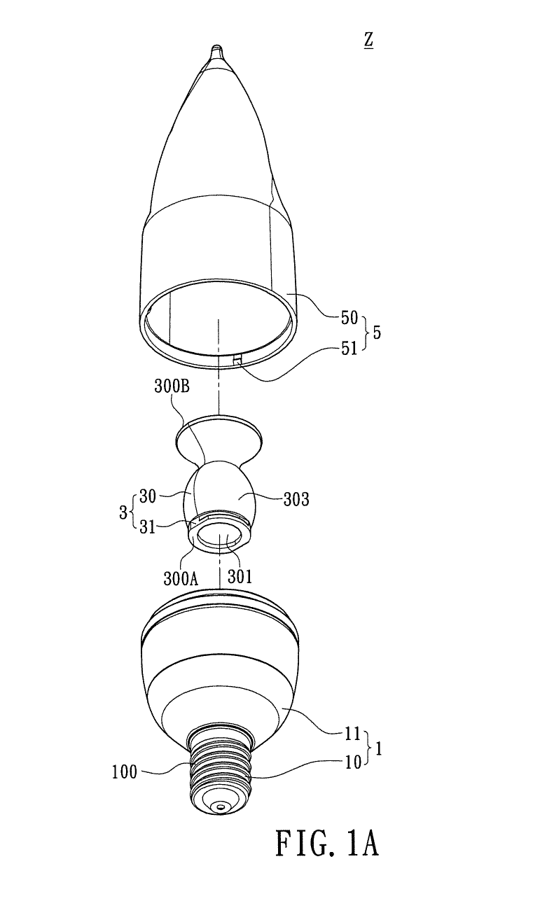

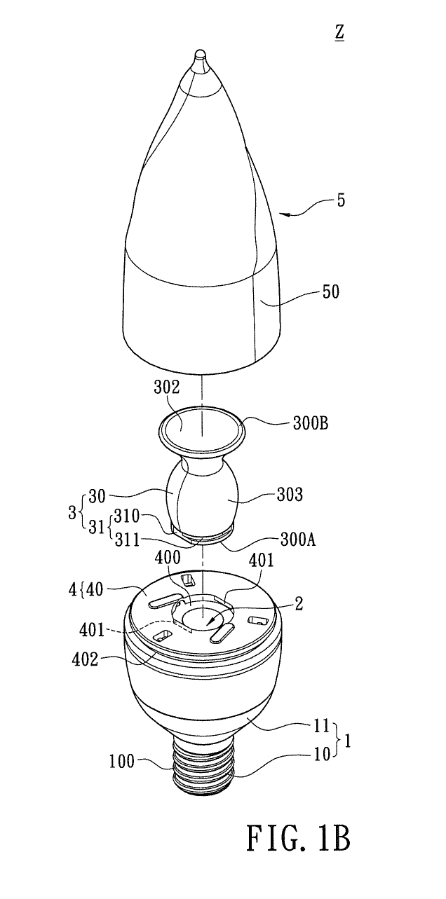

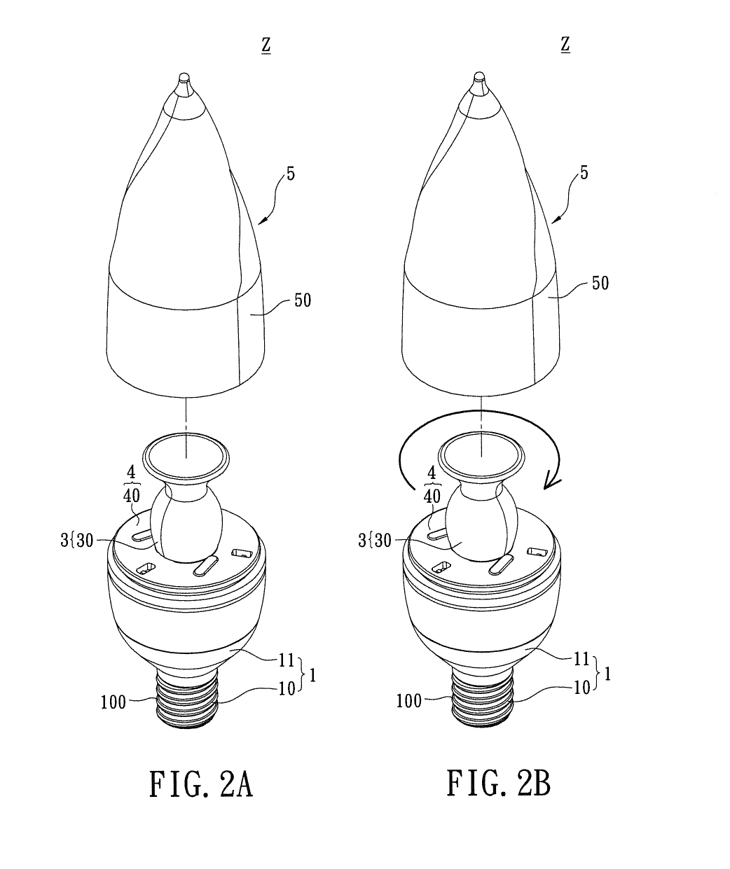

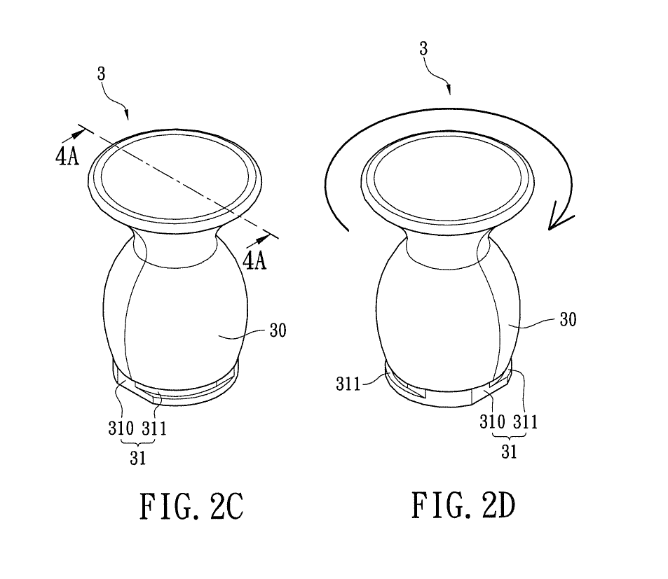

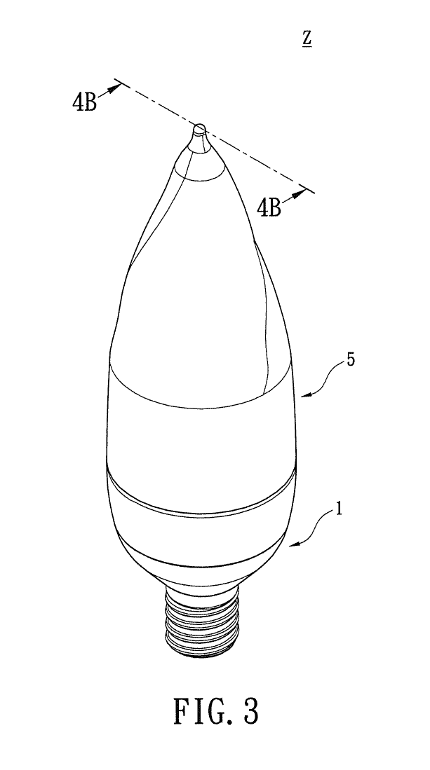

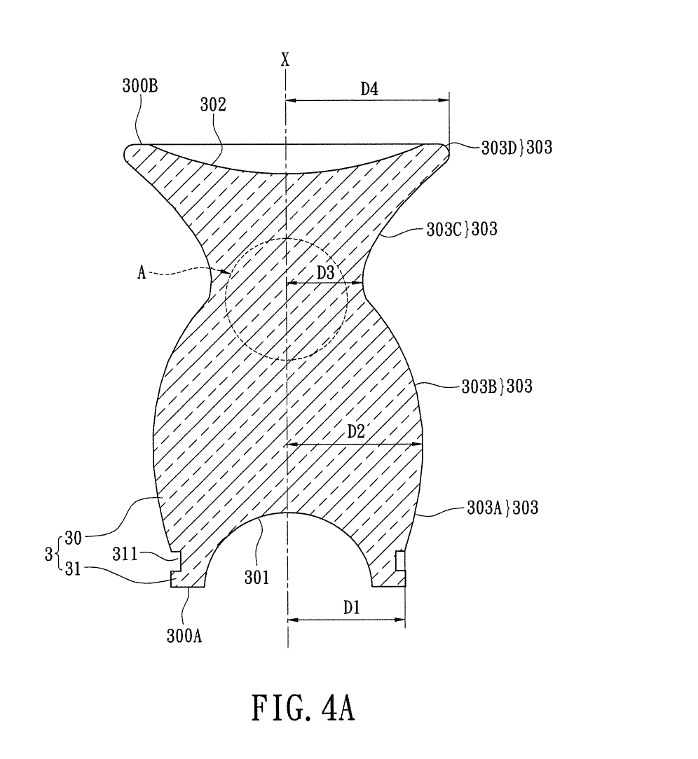

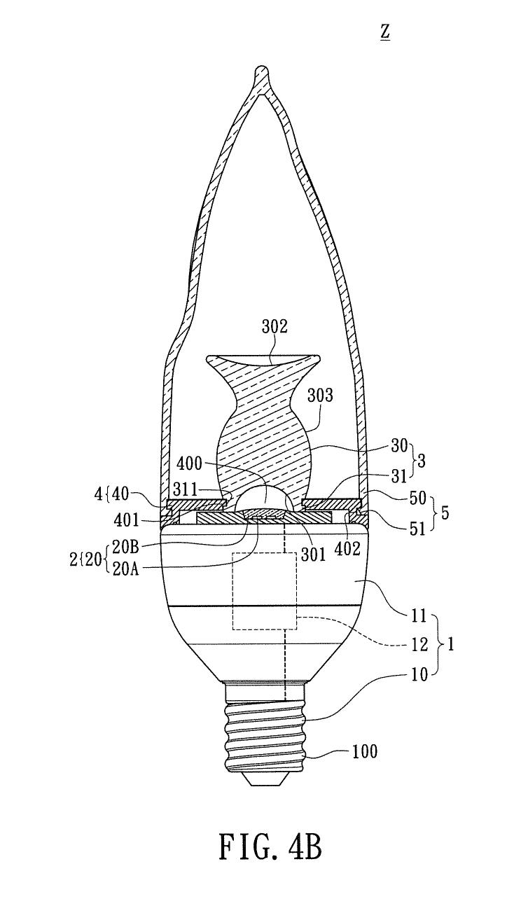

Referring to FIGS. 1A to 4B, where FIGS. 1A and 1B are perspective schematic diagrams, FIGS. 2A and 2B are partial assembled schematic diagrams, FIGS. 2C and 2D are perspective schematic diagrams of the light guiding unit, FIG. 3 is perspective assembled schematic diagram, FIG. 4A is a cross-sectional schematic diagram taken along the section line 4A-4A of FIG. 2C, and FIG. 4B is a cross-sectional schematic diagram taken along the section line 4B-4B of FIG. 3. The first embodiment of the instant disclosure provides a lamp structure Z, comprising: an electrical connection unit 1, a light emitting unit 2, a light guiding unit 3, a retaining unit 4, and a lamp cover unit 5, and the light emitting unit 2 and the light guiding unit 3 are combined with each other to form a light source guiding structure.

Referring to FIGS. 1A, 1B, and 4B, the electrical connection unit 1 includes at least one electrical connection element 10 and an insulative casing 11 connected to the at least one electrical connection element 10, and the at least one electrical connection element 10 is disposed on the bottom side of the electrical connection unit 1. For example, the at least one electrical connection element 10 may be an electrical connector having a securing screw 100 formed on the external surface of the electrical connector, thus the at least one electrical connection element 10 of the lamp structure Z can be positioned in a power socket (not shown) by rotating to obtain power supply. In addition, the electrical connection unit 1 further includes at least one drive IC 12 (as shown in FIG. 4B) disposed inside the insulative casing 11, and the at least one drive IC 12 is electrically connected between the at least one electrical connection element 10 and the at least one light emitting unit 2 in order to transform voltage from AC (alternating current) into DC (Direct current), thus the instant disclosure can provide DC for the light emitting unit 2.

Referring to FIGS. 1B and 4B, the light emitting unit 2 includes a light emitting module 20 disposed on the top side of the electrical connection unit 1, and the light emitting module 20 includes at least one light emitting element 20A electrically connected to the at least one electrical connection element 10. For example, the first embodiment can use two light emitting elements 20A (as shown in FIG. 4B) for the light emitting module 20. The light emitting module 20 further includes a package resin body 20B covering the at least one light emitting element 20A, and the at least one light emitting element 20A may be a LED chip (such as a bare LED chip). In other words, when the user wants the lamp structure Z to generate white light, one or more light emitting elements 20A (such as blue LED chips) can be covered with the package resin body 20B with wavelength-converting function (such as a phosphor resin formed by mixing phosphor powders with silicon or epoxy). Of course, the light emitting element 20A may be a white LED chip, thus the white LED chip can be covered with the transparent resin and the white LED chip can directly generate white light through the transparent resin.

Referring to FIGS. 1B, 2C, 2D, 4A, and 4B, the light guiding unit 3 includes at least one light guiding element 30 disposed on the top side of the electrical connection unit 1, and the at least one light guiding element 30 has a light condensing zone A therein (as shown in FIG. 4A). The at least one light guiding element 30 has at least one bottom light-input surface 301 and at least one top light-output surface 302 respectively formed on the bottom side and the top side thereof, and the at least one light emitting element 20A faces the at least one bottom light-input surface 301. The at least one light guiding element 30 further has at least one surrounding light-output surface 303 formed on the external periphery thereof. In addition, the light guiding unit 30 further includes a bottom retaining seat 31 disposed on the bottom side of the at least one light guiding element 30. The bottom retaining seat 31 and the at least one light guiding element 30 can be integrally combined to form a single element. The bottom retaining seat 31 includes at least two corresponding plane portions 310 (as shown in FIG. 2D, but one plane portion 310 formed on the rear of the light guiding unit 3) and at least two corresponding first retaining portions 311 (as shown in FIG. 2D), and the at least two plane portions 310 are respectively connected with the at least two first retaining portions 311 (as shown in FIG. 2C). In other words, referring to FIG. 2C, in front of the light guiding unit 3, one plane portion 310 is connected with one first retaining portion 311, and in back of the light guiding unit 3, another plane portion (not shown) is connected with another first retaining portion (not shown).

For example, referring to FIG. 4A, the at least one top light-output surface 302 corresponds to the at least one bottom light-input surface 301 and disposed above the at least one bottom light-input surface 301, the at least one bottom light-input surface 301 may be a concave curved surface, and the at least one top light-output surface 302 may be a concave curved surface. In other words, the at least one light guiding element 30 has a bottom plane 300A formed on the bottom side thereof, and the at least one bottom light-input surface 301 is upwardly concaved from the bottom plane 300A to form a concave curved surface. The at least one light guiding element 30 has a top plane 300B formed on the top side thereof, and the at least one top light-output surface 302 is downwardly concaved from the top plane 300B to form a concave curved surface.

For example, referring to FIG. 4A, the at least one surrounding light-output surface 303 has a first surrounding region 303A gradually outwardly expanded from bottom to top, a second surrounding region 303B connected to the first surrounding region 303A and gradually inwardly contracted from bottom to top, a third surrounding region 303C connected to the second surrounding region 303B and gradually outwardly expanded from bottom to top, and a fourth surrounding region 303D connected to the third surrounding region 303C and gradually inwardly contracted from bottom to top. In other words, if the at least one light guiding element 30 has a central axis X and the at least one light guiding element 30 is upwardly extended around the central axis X, the distance D3 between the bottom side of the third surrounding region 303C and the central axis X is smaller than the distance D1 between the bottom side of the first surrounding region 303A and the central axis X, and the distance D4 between the top side of the third surrounding region 303C and the central axis X is larger than the distance D2 between the top side of the first surrounding region 303A and the central axis X.

Referring to FIGS. 1B, 2A-2D, and 4B, the retaining unit 4 including a retaining element 40 disposed on the top side of the electrical connection unit 1. The retaining element 40 has a receiving space 400 for exposing the light emitting unit 2 and receiving the bottom retaining seat 31 and at least two second retaining portions 401 disposed inside the receiving space 400, and the at least two first retaining portions 311 are respectively slidably mated with the at least two second retaining portions 401 (as shown in FIG. 4B). For example, each first retaining portion 311 may be a retaining groove, and each second retaining portion 401 may be a retaining body corresponding to the retaining groove and detachably received in the retaining groove. When the two plane portions 310 of the bottom retaining seat 31 respectively correspond to the two second retaining portions 401 of the retaining unit 4 (as shown in FIG. 1B), the bottom retaining seat 31 can be smoothly inserted into the receiving space 400 (as shown in FIGS. 2A and 2C) and the light guiding unit 3 can be clockwise rotated relative to the retaining unit 4 (as the direction of the arrow shown in FIGS. 2B and 2D) in order to respectively slidably mating the at least two first retaining portions 311 with the at least two second retaining portions 401. When the light guiding unit 3 is clockwise rotated relative to the retaining unit 4 by 90 degrees, the bottom retaining seat 31 can be positioned between the at least two second retaining portions 401 (as shown in FIG. 4B) in order to fix the light guiding unit 3 on the retaining unit 4.

Referring to FIGS. 1A, 1B, 3, and 4B, the lamp cover unit 5 includes a light permitting cover 50 covering the light emitting unit 2 and at least one third retaining portion 51 disposed on the bottom side of the light permitting cover 50 to mate with the retaining element 40. For example, the first embodiment can use a plurality of third retaining portions 51 (as shown in FIG. 1A) disposed on the inner surface of the light permitting cover 50, and the retaining element 40 has a fourth retaining portion 402 disposed on the outer periphery thereof. The third retaining portions 51 and the fourth retaining portion 402 can be mated with each other, thus the lamp cover unit 5 can be firmly fixed on the retaining unit 4.

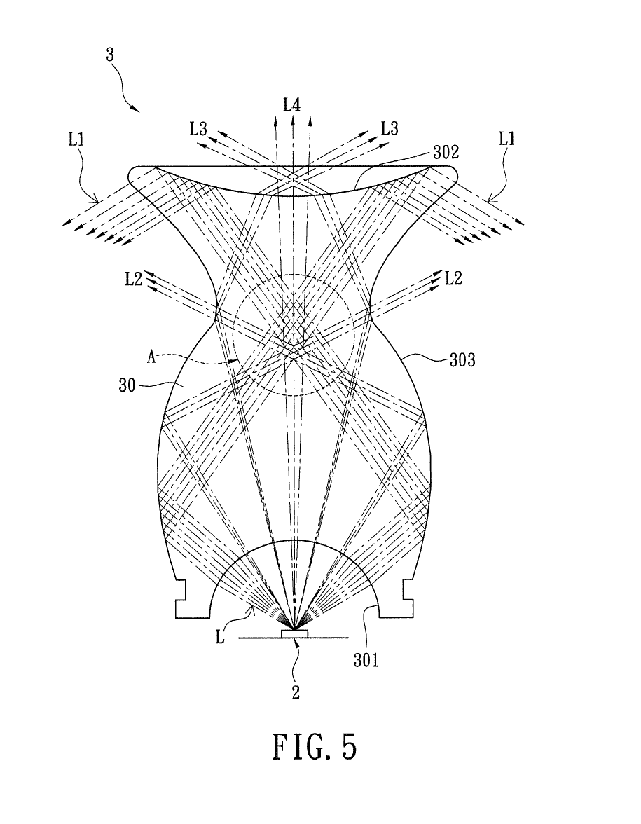

Referring to FIG. 5, light beams L generated by the light emitting unit 2 can input into the inner portion of the light guiding element 30 through the bottom light-input surface 301. The light beams L generated by the light emitting unit 2 can be guided by the light guiding element 30 to form a first projection light source L1, a second projection light source L2, a third projection light source L3, and a fourth projection light source L4. For example, the first projection light source L1 can be sequentially reflected by the surrounding light-output surface 303 and the top light-output surface 302 and then projected outside through the surrounding light-output surface 303. The second projection light source L2 can be reflected by the surrounding light-output surface 303 and then projected outside through the surrounding light-output surface 303. The third projection light source L3 can be reflected by the surrounding light-output surface 303 and then projected outside through the top light-output surface 302. The fourth projection light source L4 directly passes through the light guiding element 30 and then is projected outside through the top light-output surface 302. In other words, when the light beams L generated by the light emitting unit 2 are guided by the light guiding element 30, the light source can be concentrated in the light condensing zone A and projected above the light condensing zone A and around the light condensing zone A, thus the light source generated by the lamp structure Z can be concentrated at a predetermined position in order to increase the illumination range. However, the first projection light source L1, the second projection light source L2, the third projection light source L3, and the fourth projection light source L4 generated by the lamp structure Z in the first embodiment is merely an example and is not meant to limit the instant disclosure.

### Second Embodiment

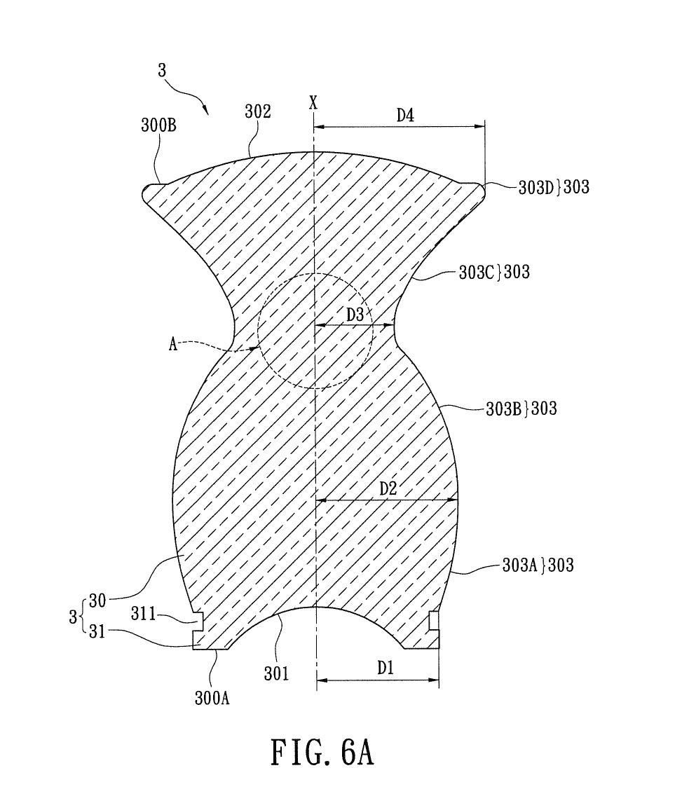

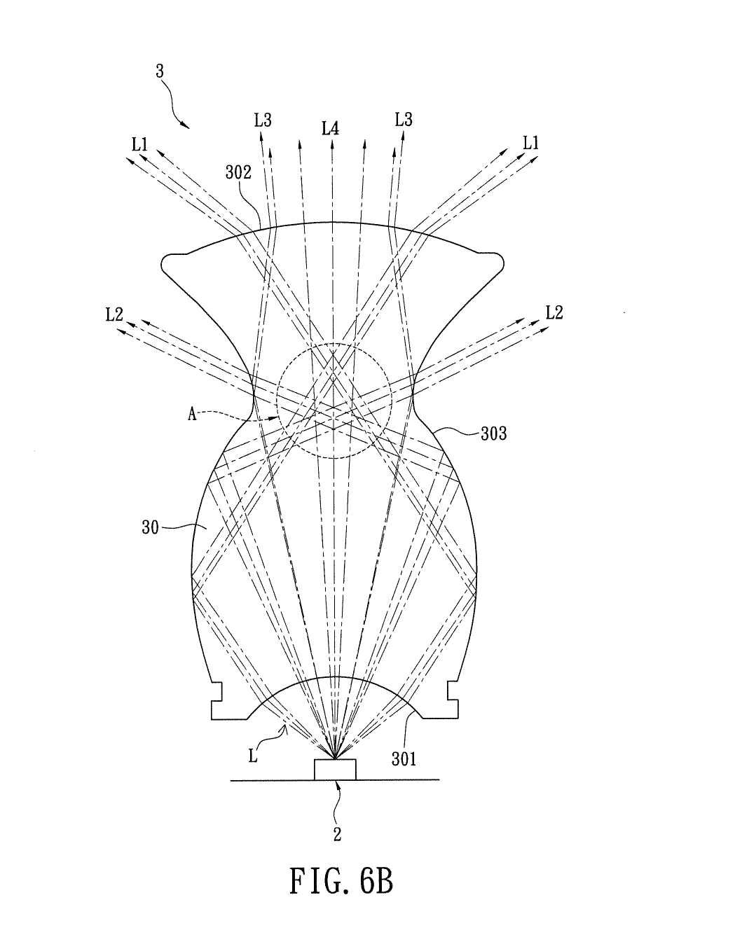

Referring to FIGS. 6A and 6B, where FIG. 6A is a cross-sectional schematic diagram, and FIG. 6B is an optical path simulation diagram. The second embodiment of the instant disclosure provides another light guiding unit 3. Comparing FIG. 6A with FIG. 4A and comparing FIG. 6B with FIG. 5, the difference between the second embodiment and the first embodiment is that: the at least one top light-output surface 302 may be a convex curved surface in the second embodiment. In other words, the at least one top light-output surface 302 is upwardly protruded from the top plane 300B to form a protrusion curved surface. Hence, referring to FIG. 6B, when the light beams L generated by the light emitting unit 2 are guided by the light guiding element 30, the light source can be concentrated in the light condensing zone A and projected above the light condensing zone A and around the light condensing zone A, thus the light source generated by the lamp structure Z can be concentrated at a predetermined position in order to increase the illumination range.

### Third Embodiment

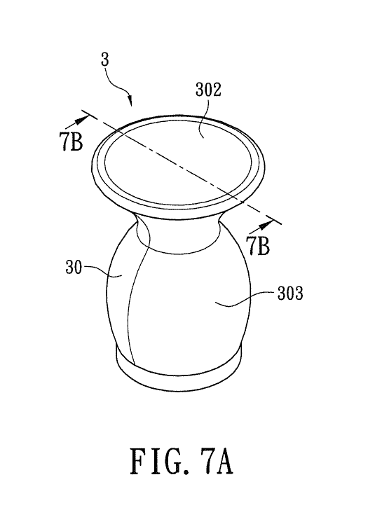

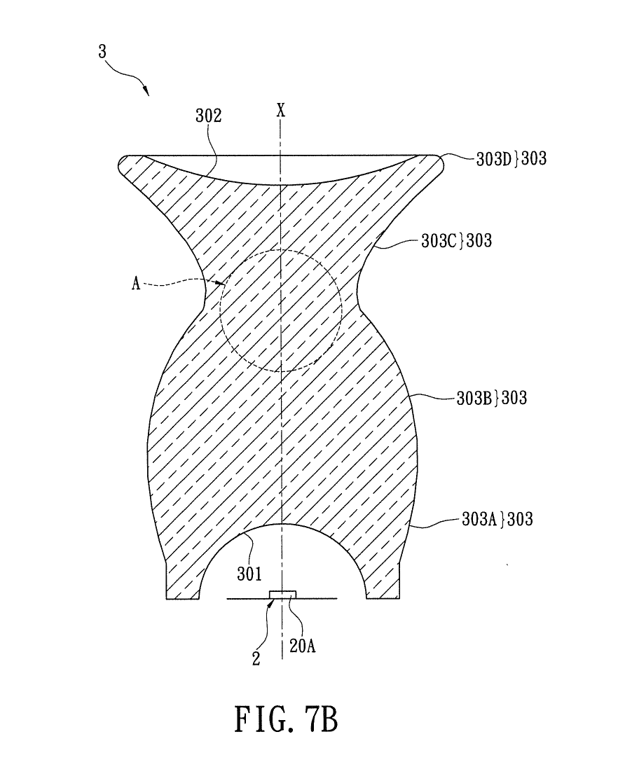

Referring to FIGS. 7A and 7B, where FIG. 7A is a perspective schematic diagram, and FIG. 7B is a cross-sectional schematic diagram taken along the section line 7B-7B of FIG. 7A. The third embodiment of the instant disclosure provides another light guiding unit 3, and the light emitting unit 2 and the light guiding unit 3 are combined with each other to form a light source guiding structure. Comparing FIG. 7B with FIG. 4A, the difference between the third embodiment and the first embodiment is that: the light guiding unit 3 can omit the manufacture of the bottom retaining seat 31 in the third embodiment. In other words, the light guiding unit 3 only includes at least one light guiding element 30. The at least one light guiding element 30 has a light condensing zone A in the inner portion thereof (as shown in FIG. 7B). The at least one light guiding element 30 has at least one bottom light-input surface 301 and at least one top light-output surface 302 respectively formed on the bottom side and the top side thereof, and the at least one light guiding element 30 further has at least one surrounding light-output surface 303 formed on the external periphery thereof. In addition, the at least one surrounding light-output surface 303 has a first surrounding region 303A gradually outwardly expanded from bottom to top, a second surrounding region 303B connected to the first surrounding region 303A and gradually inwardly contracted from bottom to top, a third surrounding region 303C connected to the second surrounding region 303B and gradually outwardly expanded from bottom to top, and a fourth surrounding region 303D connected to the third surrounding region 303C and gradually inwardly contracted from bottom to top. Hence, when the light emitting unit 2 and the light guiding unit 3 are mated with each other, the at least one light emitting element 20A of the light emitting unit 2 can face the at least one bottom light-input surface 301, and light beams generated by the at least one light emitting element 20A can be projected into the light guiding element 30.

In conclusion, because the at least one light guiding element has at least one bottom light-input surface, at least one top light-output surface, and at least one surrounding light-output surface, light source generated by the light source guiding structure and the lamp structure can be concentrated at a predetermined position in order to increase the illumination range of the instant disclosure.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. A light source guiding structure, comprising:
a light guiding unit including at least one light guiding element, wherein the at least one light guiding element has a light condensing zone therein, the at least one light guiding element has at least one bottom light-input surface and at least one top light-output surface respectively formed on the bottom side and the top side thereof, the at least one light guiding element has at least one surrounding light-output surface formed on the external periphery thereof, and the at least one surrounding light-output surface has a first surrounding region gradually outwardly expanded from bottom to top, a second surrounding region connected to the first surrounding region and gradually inwardly contracted from bottom to top, and a third surrounding region connected to the second surrounding region and gradually outwardly expanded from bottom to top; and
a light emitting unit including at least one light emitting element facing the at least one bottom light-input surface.

2. The light source guiding structure of claim 1, wherein the at least one top light-output surface corresponds to the at least one bottom light-input surface and disposed above the at least one bottom light-input surface, the at least one bottom light-input surface is a concave curved surface, and the at least one top light-output surface is a concave curved surface or a convex curved surface.

3. The light source guiding structure of claim 1, wherein the at least one light guiding element has a bottom plane formed on the bottom side thereof, and the at least one bottom light-input surface is upwardly concaved from the bottom plane to form a concave curved surface, wherein the at least one light guiding element has a top plane formed on the top side thereof, and the at least one top light-output surface is downwardly concaved from the top plane to form a concave curved surface or upwardly protruded from the top plane to form a protrusion curved surface.

4. The light source guiding structure of claim 1, wherein the at least one light guiding element has a central axis, the distance between the bottom side of the third surrounding region and the central axis is smaller than the distance between the bottom side of the first surrounding region and the central axis, and the distance between the top side of the third surrounding region and the central axis is larger than the distance between the top side of the first surrounding region and the central axis.

5. The light source guiding structure of claim 1, wherein the at least one surrounding light-output surface has a fourth surrounding region connected to the third surrounding region and gradually inwardly contracted from bottom to top.

6. The light source guiding structure of claim 1, wherein the light guiding unit includes a bottom retaining seat disposed on the bottom side of the at least one light guiding element, the bottom retaining seat and the at least one light guiding element are integrally combined to form a single element, the bottom retaining seat includes at least two corresponding plane portions and at least two corresponding first retaining portions, and the at least two plane portions are respectively connected with the at least two first retaining portions.

7. A lamp structure, comprising:
an electrical connection unit including at least one electrical connection element disposed on the bottom side thereof;
a light emitting unit including a light emitting module disposed on the top side of the electrical connection unit, wherein the light emitting module includes at least one light emitting element electrically connected to the at least one electrical connection element; and
a light guiding unit including at least one light guiding element disposed on the top side of the electrical connection unit, wherein the at least one light guiding element has a light condensing zone therein, the at least one light guiding element has at least one bottom light-input surface and at least one top light-output surface respectively formed on the bottom side and the top side thereof, the at least one light emitting element faces the at least one bottom light-input surface, the at least one light guiding element has at least one surrounding light-output surface formed on the external periphery thereof, and the at least one surrounding light-output surface has a first surrounding region gradually outwardly expanded from bottom to top, a second surrounding region connected to the first surrounding region and gradually inwardly contracted from bottom to top, and a third surrounding region connected to the second surrounding region and gradually outwardly expanded from bottom to top.

8. The lamp structure of claim 7, wherein the electrical connection unit includes an insulative casing connected to the at least one electrical connection element and at least one drive IC disposed inside the insulative casing, and the at least one drive IC is electrically connected between the at least one electrical connection element and the at least one light emitting element.

9. The lamp structure of claim 7, wherein the light emitting module includes a package resin body covering the at least one light emitting element, and the at least one light emitting element is a LED chip.

10. The lamp structure of claim 7, wherein the at least one top light-output surface corresponds to the at least one bottom light-input surface and disposed above the at least one bottom light-input surface, the at least one bottom light-input surface is a concave curved surface, and the at least one top light-output surface is a concave curved surface or a convex curved surface.

11. The lamp structure of claim 7, wherein the at least one light guiding element has a bottom plane formed on the bottom side thereof, and the at least one bottom light-input surface is upwardly concaved from the bottom plane to form a concave curved surface, wherein the at least one light guiding element has a top plane formed on the top side thereof, and the at least one top light-output surface is downwardly concaved from the top plane to form a concave curved surface or upwardly protruded from the top plane to form a protrusion curved surface.

12. The lamp structure of claim 7, wherein the at least one light guiding element has a central axis, the distance between the bottom side of the third surrounding region and the central axis is smaller than the distance between the bottom side of the first surrounding region and the central axis, and the distance between the top side of the third surrounding region and the central axis is larger than the distance between the top side of the first surrounding region and the central axis.

13. The lamp structure of claim 7, wherein the at least one surrounding light-output surface has a fourth surrounding region connected to the third surrounding region and gradually inwardly contracted from bottom to top.

14. The lamp structure of claim 7, wherein the light guiding unit includes a bottom retaining seat disposed on the bottom side of the at least one light guiding element, the bottom retaining seat and the at least one light guiding element are integrally combined to form a single element, the bottom retaining seat includes at least two corresponding plane portions and at least two corresponding first retaining portions, and the at least two plane portions are respectively connected with the at least two first retaining portions.

15. The lamp structure of claim 7, further comprising: a retaining unit including a retaining element disposed on the top side of the electrical connection unit, wherein the retaining element has a receiving space for exposing the light emitting unit and receiving the bottom retaining seat and at least two second retaining portions disposed inside the receiving space, and the at least two first retaining portions are respectively slidably mated with the at least two second retaining portions.

16. The lamp structure of claim 15, wherein each first retaining portion is a retaining groove, and each second retaining portion is a retaining body corresponding to the retaining groove and detachably received in the retaining groove.

17. The lamp structure of claim 15, further comprising: a lamp cover unit including a light permitting cover covering the light emitting unit and at least one third retaining portion disposed on the bottom side of the light permitting cover to mate with the retaining element, wherein the retaining element has a fourth retaining portion disposed on the outer periphery thereof, and the at least one third retaining portion and the fourth retaining portion are mated with each other.

18. A light source guiding structure, comprising:
a light guiding unit including at least one light guiding element, wherein the at least one light guiding element has a light condensing zone therein, the at least one light guiding element has at least one bottom light-input surface and at least one top light-output surface respectively formed on the bottom side and the top side thereof, and the at least one light guiding element has at least one surrounding light-output surface formed on the external periphery thereof; and
a light emitting unit including at least one light emitting element facing the at least one bottom light-input surface.

19. The light source guiding structure of claim 18, wherein the at least one surrounding light-output surface has a first surrounding region gradually outwardly expanded from bottom to top, a second surrounding region connected to the first surrounding region and gradually inwardly contracted from bottom to top, a third surrounding region connected to the second surrounding region and gradually outwardly expanded from bottom to top, and a fourth surrounding region connected to the third surrounding region and gradually inwardly contracted from bottom to top, wherein the at least one light guiding element has a central axis, the distance between the bottom side of the third surrounding region and the central axis is smaller than the distance between the bottom side of the first surrounding region and the central axis, and the distance between the top side of the third surrounding region and the central axis is larger than the distance between the top side of the first surrounding region and the central axis.

20. The light source guiding structure of claim 18, wherein the light guiding unit includes a bottom retaining seat disposed on the bottom side of the at least one light guiding element, the bottom retaining seat and the at least one light guiding element are integrally combined to form a single element, the bottom retaining seat includes at least two corresponding plane portions and at least two corresponding first retaining portions, and the at least two plane portions are respectively connected with the at least two first retaining portions.
